(19) United States
(12) Patent Application Publication
(10) Pub. No.: US 2015/0269191 A1
(43) Pub. Date: Sep. 24, 2015

(54) METHOD FOR RETRIEVING SIMILAR IMAGE BASED ON VISUAL SALIENCIES AND VISUAL PHRASES

(71) Applicant: Beijing University of Technology, Beijing (CN)

(72) Inventors: Lijuan Duan, Beijing (CN); Wei Ma, Beijing (CN); Zeming Zhao, Beijing (CN); Xuan Zhang, Beijing (CN); Jun Miao, Beijing (CN)

(21) Appl. No.: 14/603,376

(22) Filed: Jan. 23, 2015

(30) Foreign Application Priority Data
Mar. 20, 2014 (CN) 201410105536.X

(51) Int. Cl. G06F 17/30

(52) U.S. Cl. CPC G06F 17/30256

(57) ABSTRACT

The present invention discloses a method for retrieving a similar image based on visual saliencies and visual phrases, comprising: inputting an inquired image; calculating a saliency map of the inquired image; performing viewpoint shift on the saliency map by utilizing a viewpoint shift model, defining a saliency region as a circular region which taking a viewpoint as a center and R as a radius, and shifting the viewpoint for k times to obtain k saliency regions of the inquired image; extracting a visual word in each of the saliency regions of the inquired image, to constitute a visual phrase, and jointing k visual phrases to generate an image descriptor of the inquired image; obtaining an image descriptor for each image of an inquired image library; and calculating a similarity value between the inquired image and each image in the inquired image library depending on the image descriptors by utilizing a cosine similarity, to obtain an image similar to the inquired image from the inquired image library. Through the present invention, noise in expression of an image is reduced, so that the expression of the image in a computer may be more consistent with human understanding of the semantics of the image, presenting a better retrieving effect and a higher retrieving speed.

### CROSS-REFERENCE TO RELATED APPLICATION

This application claims the priority benefit of Chinese patent application No. 201410105536.x, filed Mar. 20, 2014. The entirety of the above-mentioned patent application is hereby incorporated by reference herein and made a part of specification.

### TECHNICAL FIELD

The present invention belongs to the field of image processing, relates to a presentation and matching method in retrieval of images, and more particularly, to a method for retrieving a similar image based on visual saliencies and visual phrases.

### BACKGROUND

With rapid development and application of computer, networking and multimedia technology, digital images are increasing at an astonishing rate. How to quickly and efficiently find a wanted image from a collection of digital images of a huge quantity has become an urgent problem. To this end, the image retrieval technology has emerged and has achieved considerable development, from earliest manual annotation-based image retrieval to current content-based image retrieval, and accuracy and efficiency in image retrieval has also been significantly improved. However, it is still not satisfying. A key problem is that currently there is not a method which is capable of make computers to fully understand image semantics like humans. If true meaning of an image may be further explored and expressed in a computer, image retrieval effects may be definitely improved.

In image retrieval related literatures, currently a “bag of words” model is widely used for retrieval, which is based on a core idea that an entire image may be described by extracting and describing partial features of the image. The method mainly includes five steps: firstly, detecting feature points or angular points of an image, usually referred to as interest points; secondly, describing the interest points, usually with one vector describing one point, and the vector being referred to as a descriptor of the point; thirdly, clustering descriptors of all interest points of a training sample image, to obtain a dictionary containing a plurality of words; fourthly, mapping descriptors of all interest points of an inquired image to the dictionary, to obtain image descriptors; and fifthly, mapping descriptors of all interest points of each image in an inquired image library to the dictionary, to obtain image descriptors, and matching them with the image descriptors of the inquired image, to obtain a retrieval result. The model may achieve an excellent effect in retrieving an image. However, it loses spatial relationships between visual words in expressing an image since it merely calculates visual words resulted from the mapping.

On the other hand, in image retrieval based on the “bag of words” model, visual words are extracted with respect to the whole image, so it is easy to introduce much noise. For example, for some images, background is not a region which is really cared about, and it cannot express semantics contained in the images, so extracting visual words from a background region of the image may not only increase redundant information, but also affect an expression effect of the image.

### SUMMARY

In order to overcome the above problems, the present invention provides a method for retrieving a similar image based on visual saliencies and visual phrases, in which visual saliency is introduced to constrain regions of an image on the basis of the conventional “bag of words” model, to reduce noise in expressing the image, and make the expression of the image in a computer being more consistent with human understanding of the semantics of the image, so that the present invention presents a better retrieving effect. Moreover, visual phrases are constructed merely through region constraints between visual words, so that the present invention presents a higher retrieving speed compared to other methods for constructing visual phrases.

One object of the present invention is to provide a method for retrieving a similar image based on visual saliencies and visual phrases, comprising the following steps:

step 1), inputting an inquired image I;

step 2), calculating a saliency map of the inquired image I;

step 3), performing viewpoint shift on the saliency map of the inquired image I obtained in step 2) by utilizing a viewpoint shift model, defining a saliency region as a circular region which taking a viewpoint as a center and R as a radius, and shifting the viewpoint for k times to obtain k saliency regions of the inquired image;

step 4), extracting a visual word in each of the saliency regions of the inquired image I, to constitute a visual phrase, and jointing k visual phrases to generate an image descriptor V(Iᵢ) of the inquired image I;

step 5), performing steps 1), 2), 3) and 4) with respect to each image in an inquired image library, until an image descriptor V(I_{i′}) of each image is obtained; and

step 6), calculating a similarity value between the inquired image and each image in the inquired image library depending on the image descriptors by utilizing a cosine similarity, to obtain an image similar to the inquired image from the inquired image library.

Preferably, for the method for retrieving a similar image based on visual saliencies and visual phrases, in the step 3), shifting the viewpoint for k times is taking former k viewpoints of each image.

Preferably, for the method for retrieving a similar image based on visual saliencies and visual phrases, in the step 6), ranking all images in the inquired image library depending on the similarity values, and selecting at least one image which has the largest similarity value as the similar image.

Preferably, for the method for retrieving a similar image based on visual saliencies and visual phrases, in the step 6), calculating a similarity value between two images V(Iᵢ) and V(I_{i′}) by utilizing a cosine similarity through a formula:

$$cos < V ( {I}_{i} ) , V ( {I}_{{i}^{′}} ) >= \frac{V ( {I}_{i} ) \cdot V ( {I}_{{i}^{′}} )}{‖ V ( {I}_{i} ) ‖ \cdot ‖ V ( {I}_{{i}^{′}} ) ‖}$$

wherein, cos <V(Iᵢ), V(I_{i′})> represents a similarity value between two images V(Iᵢ) and V(I_{i′}).

Preferably, for the method for retrieving a similar image based on visual saliencies and visual phrases, the step 4) comprises the following steps:

step 4.1), constructing a dictionary: extracting SIFT feature points from different types of images in the inquired image library by utilizing a SIFT algorithm, for a set of vectors of all SIFT feature points, merging similar SIFT feature points by utilizing a K-Means clustering algorithm, to construct a dictionary containing m words;

step 4.2), extracting a number of appearance times of each word of the m visual words in each saliency region of the inquired image I, and a number of appearance times of a j-th visual word wordⱼ^{(k)} in a k-th saliency region regionₖ being denoted as ωⱼ^{(k)};

step 4.3), constructing a visual phrase: wordⱼ^{(k)} and wordⱼ^{(k)} constituting a visual phrase phrase_{jj′(k)} if both of the two different visual words wordⱼ^{(k)} and word_{j′}^{(k)} appear in a same saliency region and j≠j′;

step 4.4), calculating a frequency of a visual phrase:

firstly, respectively calculating a number of appearance times p_{jj′}^{(k)} of a visual phrase phrase_{jj′(k)} in each of the saliency regions: taking a minimum one of the numbers of appearance times of two different visual words wordⱼ^{(k)} and word_{j′}^{(k)} as the number of appearance times p_{jj′}^{(k)} of the visual phrase_{jj′}^{(k)} consisting of the two words:

p_{jj′}^{(k)}=min(ωⱼ^{(k)},ω_{j′}^{(k)})

secondly, representing numbers of appearance times of all of the visual phrases in the saliency region regionₖ as:

$${P}^{( k )} = [ \begin{matrix}{p}_{11}^{( k )} & {p}_{12}^{( k )} & … & {p}_{1 m}^{( k )} \\ {p}_{21}^{( k )} & {p}_{22}^{( k )} & … & {p}_{2 m}^{( k )} \\ ⋮ & ⋮ & ⋱ & ⋮ \\ {p}_{m 1}^{( k )} & {p}_{m 2}^{( k )} & … & {p}_{mm}^{( k )}\end{matrix} ]$$

thirdly, superimposing matrixes P^{(k)} of the former k regions, to obtain a matrix PH of numbers of appearance times of all of the visual phrases of the inquired image I:

$$PH = [ \begin{matrix}{ph}_{11} & {ph}_{12} & … & {ph}_{1 m} \\ {ph}_{21} & {ph}_{22} & … & {ph}_{2 m} \\ ⋮ & ⋮ & ⋱ & ⋮ \\ {ph}_{m 1}^{( k )} & {ph}_{m 2}^{( k )} & … & {ph}_{mm}^{( k )}\end{matrix} ]$$

wherein,

$${ph}_{{jj }^{′}} = {\sum }_{i = 1}^{k} {p}_{{jj}^{′}}^{( i )}$$

step 4.5), representing the inquired image I with the visual phrases: representing the inquired image I as a matrix PH(I) according to the numbers of appearance times of all of the visual phrases in all of the saliency regions in step 4.4), wherein PH(I) is symmetric with respect to a main diagonal, and its upper triangular matrix covers all information of the matrix, and jointing an upper triangular part of PH(I) row by row or column by column into a vector, to obtain a descriptor V(I) of the inquired image I.

Preferably, for the method for retrieving a similar image based on visual saliencies and visual phrases, the step 2) comprises the following steps:

step 2.1), dividing the inquired image I into L non-overlapping image blocks pᵢ, i=1, 2, 3, . . . , L, such that after the division the inquired image contains N image blocks at each row and J image blocks at each column and each image block is a square block, vectorizing each image block pᵢ into a column vector fᵢ, decreasing dimensions of all the vectors through a principal component analysis algorithm, to obtain a d×L matrix U of which an i-th column corresponds to a vector of an image block pᵢ with decreased dimensions; wherein the matrix U is composed of

U=[X₁ X₂ . . . X_{d}]^{T}

step 2.2), calculating a visual saliency of each image block pᵢ as:

$${Sal}_{i} = {\sum }_{i = 1}^{L} \frac{{ϕ}_{ij} / {M}_{i}}{1 + {ω}_{ij} / D}$$

$${M}_{i} = {max}_{j} \{ {ω}_{ij} \} , j = 1 , 2 , … , L$$

$$D = max \{ W , H \}$$

$${ϕ}_{ij} = {\sum }_{s = 1}^{d} \vert {u}_{si} - {u}_{sj} \vert$$

$${ω}_{ij} = \sqrt{{( {x}_{pi} - {x}_{pj} )}^{2} + {( {y}_{pi} - {y}_{pj} )}^{2}}$$

wherein, φ_{if} represents a dissimilarity between image blocks pᵢ and pⱼ, ωᵢⱼ distance between image blocks pᵢ and pⱼ, uₘ represents an element at a m-th row and a n-th column of the matrix U, (xₚᵢ,yₚᵢ) and (xₚᵢ,yₚᵢ) respectively represent coordinates of the image blocks pᵢ and pⱼ to a center on the original inquired image I;

step 2.3), organizing visual saliency values of all image blocks into a two-dimensional form according to positional relationships among the image blocks on the original inquired image I, to constitute a saliency map SalMap which is calculated as:

SalMap(i,j)=Sal_{(i-1)·N+j}i=1, . . . ,J,j=1, . . . ,N

step 2.4), imposing a central bias on the saliency map obtained in step 2.3) according to a central bias principle of human eyes, and smoothing it through a two-dimensional Gaussian smoothing operator to obtain a final resulted map, the formulas being the following:

$${SalMap}^{′} ( i , j ) = SalMap ( i , j ) \times AttWeiMap ( i , j )$$

$$AttWeiMap ( i , j ) = 1 - \frac{DistMap ( i , j ) - min \{ DistMap \}}{max \{ DistMap \} - min \{ DistMap \}}$$

$$DistMap ( i , j ) = \sqrt{{( i - ( J + 1 ) / 2 )}^{2} + {( j - ( N + 1 ) / 2 )}^{2}}$$

wherein, i=1, . . . , J, j=1, . . . , N, AttWeiMap is an average attention weight map of human eyes which has a same size as that of the saliency map SalMap, DistMap is a distance map, and max{DistMap}, min{DistMap} are respectively a maximum value and a minimum value of the distance map.

Preferably, for the method for retrieving a similar image based on visual saliencies and visual phrases, the inquired image I has a width W, a height H, if W=H, the whole inquired image is divided into L non-overlapping image square blocks, and if W≠H, after the inquired image is divided into L non-overlapping image square blocks, remaining parts which are not divided are kept at edges of the inquired image.

Another object of the present invention is to provide a method for retrieving a similar image based on visual saliencies and visual phrases, comprising the following steps:

step 1), inputting an inquired image I;

step 2), calculating a saliency map of the inquired image I;

step 3), performing viewpoint shift on the saliency map of the inquired image I obtained in step 2) by utilizing a viewpoint shift model, defining a saliency region as a circular region which taking a viewpoint as a center and R as a radius, and shifting the viewpoint for k times to obtain k saliency regions of the inquired image;

step 4), constructing a dictionary: extracting SIFT feature points from different types of images in the inquired image library by utilizing a SIFT algorithm, for a set of vectors of all SIFT feature points, merging similar SIFT feature points by utilizing a K-Means clustering algorithm, to construct a dictionary containing m words; extracting a number of appearance times of each word of the m visual words in each saliency region of the inquired image I, and a number of appearance times of a j-th visual word wordⱼ^{(k)} in a k-th saliency region regionₖ being denoted as ωⱼ^{(k)}; constructing a visual phrase: wordⱼ^{(k)} and wordⱼ^{(k)} constituting a visual phrase phrase_{jj′}^{(k)} if both of the two different visual words wordⱼ^{(k)} and word_{j′}^{(k)} appear in a same saliency region and j≠j′; calculating a frequency of a visual phrase: firstly, respectively calculating a number of appearance times p_{jj′}^{(k)} of a visual phrase phrase_{jj′}^{(k)} in each of the saliency regions: taking a minimum one of the numbers of appearance times of two different visual words wordⱼ^{(k)} and word_{j′}^{(k)} as the number of appearance times p_{jj′}^{(k)} of the visual phrase_{jj′}^{(k)} consisting of the two words:

p_{jj′}^{(k)}=min(ωⱼ^{(k)},ω_{j′}^{(k)})

secondly, representing numbers of appearance times of all of the visual phrases in the saliency region regionₖ as:

$${P}^{( k )} = [ \begin{matrix}{p}_{11}^{( k )} & {p}_{12}^{( k )} & … & {p}_{1 m}^{( k )} \\ {p}_{21}^{( k )} & {p}_{22}^{( k )} & … & {p}_{2 m}^{( k )} \\ ⋮ & ⋮ & ⋱ & ⋮ \\ {p}_{m 1}^{( k )} & {p}_{m 2}^{( k )} & … & {p}_{mm}^{( k )}\end{matrix} ]$$

thirdly, superimposing matrixes P^{(k)} of the former k regions, to obtain a matrix PH of numbers of appearance times of all of the visual phrases of the inquired image I:

$$PH = [ \begin{matrix}{ph}_{11} & {ph}_{12} & … & {ph}_{1 m} \\ {ph}_{21} & {ph}_{22} & … & {ph}_{2 m} \\ ⋮ & ⋮ & ⋱ & ⋮ \\ {ph}_{m 1}^{( k )} & {ph}_{m 2}^{( k )} & … & {ph}_{mm}^{( k )}\end{matrix} ]$$

wherein,

$${ph}_{{jj }^{′}} = {\sum }_{i = 1}^{k} {p}_{{jj}^{′}}^{( i )}$$

representing the inquired image I with the visual phrases: representing the inquired image I as a matrix PH(I) according to the numbers of appearance times of all of the visual phrases in all of the saliency regions in the previous step, wherein PH(I) is symmetric with respect to a main diagonal, and its upper triangular matrix covers all information of the matrix, and jointing an upper triangular part of PH(I) row by row or column by column into a vector, to obtain a descriptor V(I) of the inquired image I;

step 5), performing steps 1), 2), 3) and 4) with respect to each image in an inquired image library, until an image descriptor V(I_{i′}) of each image is obtained; and

step 6), calculating a similarity value between the inquired image and each image in the inquired image library depending on the image descriptors by utilizing a cosine similarity, to obtain an image similar to the inquired image from the inquired image library.

The present invention has at least advantageous effects as follows:

1. visual saliency is introduced to constrain regions of an image, to reduce noise in expressing the image, and make the expression of the image in a computer being more consistent with human understanding of the semantics of the image, so that the present invention presents a better retrieving effect;

2. visual phrases are constructed merely through region constraints between visual words, so that the present invention presents a higher retrieving speed compared to other methods for constructing visual phrases.

### BRIEF DESCRIPTION OF THE DRAWINGS

FIG. 1 is a flow chart showing a method for retrieving a similar image based on visual saliencies and visual phrases according the present invention.

FIG. 2 is a flow chart showing a process of generating an image descriptor in the method for retrieving a similar image based on visual saliencies and visual phrases according the present invention.

### DETAILED DESCRIPTION

Hereinafter, the present invention is further described in detail in conjunction with accompany drawings, to enable those skilled in the art to practice the invention with reference to the contents of the description.

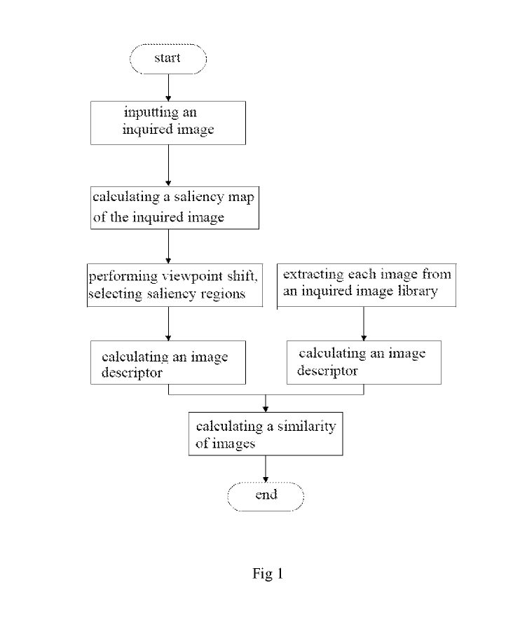

The present invention discloses a method for retrieving a similar image based on visual saliencies and visual phrases, as shown in FIG. 1, the method comprise at least the following steps:

step 1), inputting an inquired image I;

here, it is assumed that a colorful inquired image I is input, which has a width and a height respectively being W and H.

Step 2), calculating a saliency map of the inquired image I;

step 2.1), dividing the inquired image I into L non-overlapping image blocks pᵢ, i=1, 2, 3, . . . , L, such that after the division the inquired image contains N image blocks at each row and J image blocks at each column and each image block is a square block, if W=H, the whole inquired image is divided into L non-overlapping image square blocks, and if W≠H, after the inquired image is divided into L non-overlapping image square blocks, remaining parts which are not divided are kept at edges of the inquired image; vectorizing each image block pi into a column vector fᵢ, decreasing dimensions of all the vectors through a principal component analysis algorithm, to obtain a d×L matrix U of which an i-th column corresponds to a vector of an image block pᵢ with decreased dimensions; wherein the matrix U is composed of

U=[X₁ X₂ . . . X_{d}]^{T} (1)

step 2.2), calculating a visual saliency of each image block pi as:

$$\begin{matrix}{Sal}_{i} = {\sum }_{i = 1}^{L} \frac{{ϕ}_{ij} / {M}_{i}}{1 + {ω}_{ij} / D} & ( 2 ) \\ {M}_{i} = {max}_{j} \{ {ω}_{ij} \} , j = 1 , 2 , … , L & ( 3 ) \\ D = max \{ W , H \} & ( 4 ) \\ {ϕ}_{ij} = {\sum }_{s = 1}^{d} \vert {u}_{si} - {u}_{sj} \vert & ( 5 ) \\ {ω}_{ij} = \sqrt{{( {x}_{pi} - {x}_{pj} )}^{2} + {( {y}_{pi} - {y}_{pj} )}^{2}} & ( 6 )\end{matrix}$$

wherein, φᵢⱼ represents a dissimilarity between image blocks pᵢ and pⱼ, ωᵢⱼ distance between image blocks pᵢ and pⱼ, uₘₙ represents an element at a m-th row and a n-th column of the matrix U, (xₚᵢ,yₚᵢ) and (xₚⱼ,yₚⱼ) respectively represent coordinates of the image blocks pᵢ and pⱼ to a center on the original inquired image I;

step 2.3), organizing visual saliency values of all image blocks into a two-dimensional form according to positional relationships among the image blocks on the original inquired image I, to constitute a saliency map SalMap which is calculated as:

SalMap(i,j)=Sal_{(i-1)·N+j} i=1, . . . ,J, j=1, . . . ,N (7)

step 2.4), imposing a central bias on the saliency map obtained in step 2.3) according to a central bias principle of human eyes, and smoothing it through a two-dimensional Gaussian smoothing operator to obtain a final resulted map, the formulas being the following:

$$\begin{matrix}{SalMap}^{′} ( i , j ) = SalMap ( i , j ) \times AttWeiMap ( i , j ) & ( 8 ) \\ AttWeiMap ( i , j ) = 1 - \frac{DistMap ( i , j ) - min \{ DistMap \}}{max \{ DistMap \} - min \{ DistMap \}} & ( 9 ) \\ DistMap ( i , j ) = \sqrt{{( i - ( J + 1 ) / 2 )}^{2} + {( j - ( N + 1 ) / 2 )}^{2}} & ( 10 )\end{matrix}$$

wherein, i=1, . . . , J, j=1, . . . , N, AttWeiMap is an average attention weight map of human eyes which has a same size as that of the saliency map SalMap, DistMap is a distance map, and max{DistMap}, min{DistMap} are respectively a maximum value and a minimum value of the distance map.

Step 3), performing viewpoint shift on the saliency map of the inquired image I obtained in step 2) by utilizing a viewpoint shift model, defining a saliency region as a circular region which taking a viewpoint as a center and R as a radius, and shifting the viewpoint for k times to obtain k saliency regions of the inquired image;

wherein, selection of the viewpoints is: taking a pixel point as a viewpoint, and shifting the viewpoint for k times is taking former k viewpoints of each image.

Step 4), extracting a visual word in each of the saliency regions of the inquired image I, to constitute a visual phrase, and jointing k visual phrases to generate an image descriptor V(Iᵢ) of the inquired image I;

step 4.1), constructing a dictionary: extracting SIFT feature points from different types of images in the inquired image library by utilizing a SIFT algorithm, for a set of vectors of all SIFT feature points, merging similar SIFT feature points by utilizing a K-Means clustering algorithm, to construct a dictionary containing m words;

step 4.2), extracting a number of appearance times of each word of the m visual words in each saliency region of the inquired image I, and a number of appearance times of a j-th visual word wordⱼ^{(k)} in a k-th saliency region regionₖ being denoted as ωⱼ^{(k)};

step 4.3), constructing a visual phrase: wordⱼ^{(k)} and word_{j′}^{(k)} constituting a visual phrase phrase_{jj′}^{(k)} if both of the two different visual words wordⱼ^{(k)} and word_{j′}^{(k)} appear in a same saliency region and j≠j;

step 4.4), calculating a frequency of a visual phrase:

firstly, respectively calculating a number of appearance times p_{jj′}^{(k)} of a visual phrase phrase_{jj′}^{(k)} in each of the saliency regions: taking a minimum one of the numbers of appearance times of two different visual words wordⱼ^{(k)} and word_{j′}^{(k)} as the number of appearance times p_{jj′}^{(k)} of the visual phrase_{jj′}^{(k)} consisting of the two words:

p_{jj′}^{(k)}=min(ωⱼ^{(k)},ω_{j′}^{(k)}) (11)

secondly, representing numbers of appearance times of all of the visual phrases in the saliency region regionₖ as:

$${P}^{( k )} = [ \begin{matrix}{p}_{11}^{( k )} & {p}_{12}^{( k )} & … & {p}_{1 m}^{( k )} \\ {p}_{21}^{( k )} & {p}_{22}^{( k )} & … & {p}_{2 m}^{( k )} \\ ⋮ & ⋮ & ⋱ & ⋮ \\ {p}_{m 1}^{( k )} & {p}_{m 2}^{( k )} & … & {p}_{mm}^{( k )}\end{matrix} ] \qquad ( 12 )$$

wherein, p₁₁^{(k)}, p₂₂^{(k)}, . . . pₘₘ^{(k)} has no specific values, they are listed in the matrix for quick and easy arrangement of the matrix. So the calculation skips p₁₁^{(k)}, p₂₂^{(k)}, . . . pₘₘ^{(k)} and begins with p₁₂^{(k)} in a row and p₂₁^{(k)} in a column. p₁ₘ^{(k)} represents a number of appearance times of a visual phrase consisting of a 1^{st} visual word and a m-th visual word, that is, a minimum one of the numbers of appearance times of the 1^{st} visual word and the m-th visual word, and pₘ₁^{(k)} represents a number of appearance times of a visual phrase consisting of a m-th visual word and a 1^{st} visual word, that is, a minimum one of the numbers of appearance times of the m-th visual word and the 1^{st} visual word. Therefore, p₁ₘ^{(k)}=pₘ₁^{(k)}, and p₂ₘ^{(k)=p}ₘ₂^{(k)}, . . . .

Thirdly, superimposing matrixes P^{(k)} of the former k regions, to obtain a matrix PH of numbers of appearance times of all of the visual phrases of the inquired image I:

$$PH = [ \begin{matrix}{ph}_{11} & {ph}_{12} & … & {ph}_{1 m} \\ {ph}_{21} & {ph}_{22} & … & {ph}_{2 m} \\ ⋮ & ⋮ & ⋱ & ⋮ \\ {ph}_{m 1} & {ph}_{m 2} & … & {ph}_{mm}\end{matrix} ] \qquad ( 13 )$$

wherein,

$${ph}_{{jj}^{′}} = {\sum }_{i = 1}^{k} {p}_{{jj}^{′}}^{( i )}$$

step 4.5), representing the inquired image I with the visual phrases: representing the inquired image I as a matrix PH(I) according to the numbers of appearance times of all of the visual phrases in all of the saliency regions in step 4.4), wherein PH(I) is symmetric with respect to a main diagonal which is a straight line where ph₁₁, ph₂₂, . . . phₘₘ are located in the matrix PH, and information of the matrix covered by its upper triangular matrix and that covered by its lower triangular matrix are same, so the upper triangular matrix or the lower triangular matrix covers all information of the matrix; jointing an upper triangular part or a lower triangular part of PH(I) row by row or column by column into a vector, to obtain a descriptor V(I) of the inquired image I.

Step 5), performing steps 1), 2), 3) and 4) with respect to each image in an inquired image library, until an image descriptor V(I_{i′}) of each image is obtained; and

step 6), calculating a similarity value between the inquired image and each image in the inquired image library depending on the image descriptors by utilizing a cosine similarity, to obtain an image similar to the inquired image from the inquired image library.

Wherein, all images in the inquired image library are ranked depending on the similarity values, and at least one image which has the largest similarity value is selected as the similar image.

A similarity value between two images V(Iᵢ) and V(I_{i′}) by utilizing a cosine similarity is calculated through a formula:

$$cos < V ( {I}_{i} ) , V ( {I}_{{i}^{′}} ) >= \frac{V ( {I}_{i} ) \cdot V ( {I}_{{i}^{′}} )}{‖ V ( {I}_{i} ) ‖ \cdot ‖ V ( {I}_{{i}^{′}} ) ‖} \qquad ( 14 )$$

wherein, cos <V(Iᵢ), V(I_{i′})> represents a similarity value between two images V(Iᵢ) and V(I_{i′}).

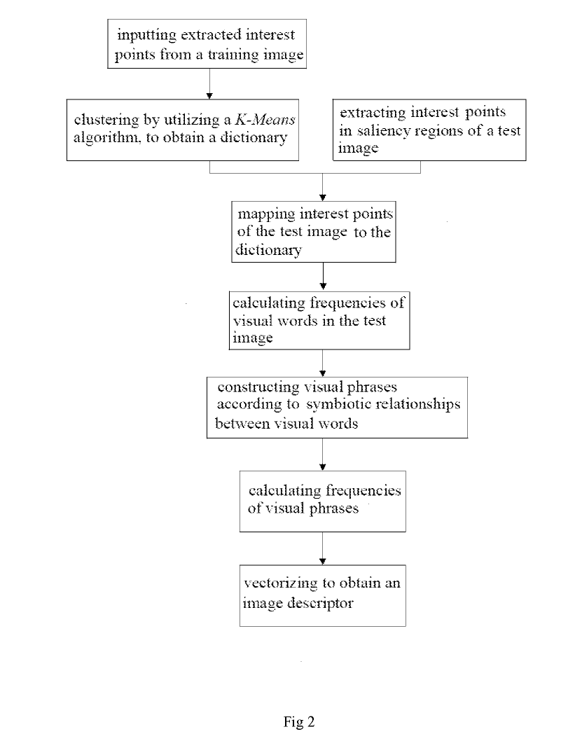

As shown in FIG. 2, which is a flow chart showing a process of generating an image descriptor in the method for retrieving a similar image based on visual saliencies and visual phrases.

step 4.1), constructing a dictionary: extracting SIFT feature points from different types of images in the inquired image library by utilizing a SIFT algorithm, for a set of vectors of all SIFT feature points, merging similar SIFT feature points by utilizing a K-Means clustering algorithm, to construct a dictionary containing m words;

step 4.2), extracting a number of appearance times of each word of the m visual words in each saliency region of the inquired image I, and a number of appearance times of a j-th visual word wordⱼ^{(k)} in a k-th saliency region regionₖ being denoted as ωⱼ^{(k)};

step 4.3), constructing a visual phrase: wordⱼ^{(k)} and word_{j′}^{(k)} constituting a visual phrase phrase_{jj′}^{(k)} if both of the two different visual words wordⱼ^{(k)} and word_{j′}^{(k)} appear in a same saliency region and j≠j′;

step 4.4), calculating a frequency of a visual phrase:

firstly, respectively calculating a number of appearance times p_{jj′}^{(k)} of a visual phrase phrase_{jj′}^{(k)} in each of the saliency regions: taking a minimum one of the numbers of appearance times of two different visual words wordⱼ^{(k)} and word_{j′}^{(k)} as the number of appearance times p_{jj′}^{(k)} of the visual phrase_{jj′}^{(k)} consisting of the two words:

p_{jj′}^{(k)}=min(ωⱼ^{(k)},ω_{j′}^{(k)}) (11)

secondly, representing numbers of appearance times of all of the visual phrases in the saliency region regionₖ as:

$${P}^{( k )} = [ \begin{matrix}{p}_{11}^{( k )} & {p}_{12}^{( k )} & … & {p}_{1 m}^{( k )} \\ {p}_{21}^{( k )} & {p}_{22}^{( k )} & … & {p}_{2 m}^{( k )} \\ ⋮ & ⋮ & ⋱ & ⋮ \\ {p}_{m 1}^{( k )} & {p}_{m 2}^{( k )} & … & {p}_{mm}^{( k )}\end{matrix} ] \qquad ( 12 )$$

wherein, p₁₁^{(k)}, p₂₂^{(k)}, . . . pₘₘ^{(k)} has no specific values, they are listed in the matrix for quick and easy arrangement of the matrix. So the calculation skips p₁₁^{(k)}, p₂₂^{(k)}, . . . pₘₘ^{(k)}, and begins with p₁₂^{(k)} in a row and p₂₁^{(k)} in a column. p₁ₘ^{(k)} represents a number of appearance times of a visual phrase consisting of a 1^{st} visual word and a m-th visual word, that is, a minimum one of the numbers of appearance times of the 1^{st} visual word and the m-th visual word, and pₘ₁^{(k)} represents a number of appearance times of a visual phrase consisting of a m-th visual word and a 1^{st} visual word, that is, a minimum one of the numbers of appearance times of the m-th visual word and the 1^{st} visual word. Therefore, p₁ₘ^{(k)}, pₘ₁^{(k)}, and p₂ₘ^{(k)}=pₘ₂^{(k)}, . . . .

Thirdly, superimposing matrixes P^{(k)} of the former k regions, to obtain a matrix PH of numbers of appearance times of all of the visual phrases of the inquired image I:

$$PH = [ \begin{matrix}{ph}_{11} & {ph}_{12} & … & {ph}_{1 m} \\ {ph}_{21} & {ph}_{22} & … & {ph}_{2 m} \\ ⋮ & ⋮ & ⋱ & ⋮ \\ {ph}_{m 1} & {ph}_{m 2} & … & {ph}_{mm}\end{matrix} ] \qquad ( 13 )$$

wherein,

$${ph}_{{jj}^{′}} = {\sum }_{i = 1}^{k} {p}_{{jj}^{′}}^{( i )}$$

step 4.5), representing the inquired image I with the visual phrases: representing the inquired image I as a matrix PH(I) according to the numbers of appearance times of all of the visual phrases in all of the saliency regions in step 4.4), wherein PH(I) is symmetric with respect to a main diagonal which is a straight line where ph₁₁, ph₂₂, . . . phₘₘ are located in the matrix PH, and information of the matrix covered by its upper triangular matrix and that covered by its lower triangular matrix are same, so the upper triangular matrix or the lower triangular matrix covers all information of the matrix; jointing an upper triangular part or a lower triangular part of PH(I) row by row or column by column into a vector, to obtain a descriptor V(I) of the inquired image I.

Although the embodiments of the present invention/utility model have been disclosed as above, they are not limited merely to those set forth in the description and the embodiments, and they may be applied to various fields suitable for the present utility model. For those skilled in the art, other modifications may be easily achieved, and the present utility model is not limited to the particular details and illustrations shown and described herein, without departing from the general concept defined by the claims and their equivalents.

What is claimed is:

1. A method for retrieving a similar image based on visual saliencies and visual phrases, characterized in that the method comprises the following steps:
step 1), inputting an inquired image I;
step 2), calculating a saliency map of the inquired image I;
step 3), performing viewpoint shift on the saliency map of the inquired image I obtained in step 2) by utilizing a viewpoint shift model, defining a saliency region as a circular region which taking a viewpoint as a center and R as a radius, and shifting the viewpoint for k times to obtain k saliency regions of the inquired image;
step 4), extracting a visual word in each of the saliency regions of the inquired image I, to constitute a visual phrase, and jointing k visual phrases to generate an image descriptor V(Iᵢ) of the inquired image I;
step 5), performing steps 1), 2), 3) and 4) with respect to each image in an inquired image library, until an image descriptor V(I_{i′}) of each image is obtained; and
step 6), calculating a similarity value between the inquired image and each image in the inquired image library depending on the image descriptors by utilizing a cosine similarity, to obtain an image similar to the inquired image from the inquired image library.

2. The method for retrieving a similar image based on visual saliencies and visual phrases of claim 1, characterized in that, in the step 3), shifting the viewpoint for k times is taking former k viewpoints of each image.

3. The method for retrieving a similar image based on visual saliencies and visual phrases of claim 2, characterized in that, in the step 6), ranking all images in the inquired image library depending on the similarity values, and selecting at least one image which has the largest similarity value as the similar image.

4. The method for retrieving a similar image based on visual saliencies and visual phrases of claim 3, characterized in that, in the step 6), calculating a similarity value between two images V(Iᵢ) and V(I_{i′}) by utilizing a cosine similarity through a formula:
$$cos < V ( {I}_{i} ) , V ( {I}_{{i}^{′}} ) >= \frac{V ( {I}_{i} ) \cdot V ( {I}_{{i}^{′}} )}{‖ V ( {I}_{i} ) ‖ \cdot ‖ V ( {I}_{{i}^{′}} ) ‖}$$
wherein, cos <V(Iᵢ), V(I_{i′})> represents a similarity value between two images V(Iᵢ) and V(I_{i′}).

5. The method for retrieving a similar image based on visual saliencies and visual phrases of claim 4, characterized in that, the step 4) comprises the following steps:
step 4.1), constructing a dictionary: extracting SIFT feature points from different types of images in the inquired image library by utilizing a SIFT algorithm, for a set of vectors of all SIFT feature points, merging similar SIFT feature points by utilizing a K-Means clustering algorithm, to construct a dictionary containing m words;
step 4.2), extracting a number of appearance times of each word of the m visual words in each saliency region of the inquired image I, and a number of appearance times of a j-th visual word wordⱼ^{(k)} in a k-th saliency region regionₖ being denoted as ωⱼ^{(k)};
step 4.3), constructing a visual phrase: wordⱼ^{(k)} and word_{j′}^{(k)} constituting a visual phrase phraseⱼₖ^{(k)} if both of the two different visual words wordⱼ^{(k)} and word_{j′}^{(k)} appear in a same saliency region and j≠j′;
step 4.4), calculating a frequency of a visual phrase:
firstly, respectively calculating a number of appearance times p_{jj′}^{(k)} of a visual phrase phrase_{jj′}^{(k)} in each of the saliency regions: taking a minimum one of the numbers of appearance times of two different visual words wordⱼ^{(k)} and word_{j′}^{(k)} as the number of appearance times p_{jj′}^{(k)} of the visual phrase_{jj′}^{(k)} consisting of the two words:
p_{jj′}^{(k)}=min(ωⱼ^{(k)},ω_{j′}^{(k)})
secondly, representing numbers of appearance times of all of the visual phrases in the saliency region regionₖ as:
$${P}^{( k )} = [ \begin{matrix}{p}_{11}^{( k )} & {p}_{12}^{( k )} & … & {p}_{1 m}^{( k )} \\ {p}_{21}^{( k )} & {p}_{22}^{( k )} & … & {p}_{2 m}^{( k )} \\ ⋮ & ⋮ & ⋱ & ⋮ \\ {p}_{m 1}^{( k )} & {p}_{m 2}^{( k )} & … & {p}_{mm}^{( k )}\end{matrix} ]$$
thirdly, superimposing matrixes P^{(k)} of the former k regions, to obtain a matrix PH of numbers of appearance times of all of the visual phrases of the inquired image I:
$$PH = [ \begin{matrix}{ph}_{11} & {ph}_{12} & … & {ph}_{1 m} \\ {ph}_{21} & {ph}_{22} & … & {ph}_{2 m} \\ ⋮ & ⋮ & ⋱ & ⋮ \\ {ph}_{m 1} & {ph}_{m 2} & … & {ph}_{mm}\end{matrix} ]$$
wherein,
$${ph}_{{jj}^{′}} = {\sum }_{i = 1}^{k} {p}_{{jj}^{′}}^{( i )}$$
step 4.5), representing the inquired image I with the visual phrases: representing the inquired image I as a matrix PH(I) according to the numbers of appearance times of all of the visual phrases in all of the saliency regions in step 4.4), wherein PH(I) is symmetric with respect to a main diagonal, and its upper triangular matrix covers all information of the matrix, and jointing an upper triangular part of PH(I) row by row or column by column into a vector, to obtain a descriptor V(I) of the inquired image I.

6. The method for retrieving a similar image based on visual saliencies and visual phrases of claim 5, characterized in that, the step 2) comprises the following steps:
step 2.1), dividing the inquired image I into L non-overlapping image blocks pᵢ, i=1, 2, 3, . . . , L, such that after the division the inquired image contains N image blocks at each row and J image blocks at each column and each image block is a square block, vectorizing each image block pᵢ into a column vector fᵢ, decreasing dimensions of all the vectors through a principal component analysis algorithm, to obtain a d×L matrix U of which an i-th column corresponds to a vector of an image block pᵢ with decreased dimensions; wherein the matrix U is composed of
U=[X₁ X₂ . . . X_{d}]^{T}
step 2.2), calculating a visual saliency of each image block pᵢ as:
$${Sal}_{i} = {\sum }_{i = 1}^{L} \frac{{ϕ}_{ij} / {M}_{i}}{1 + {ω}_{ij} / D}$$
$${M}_{i} = {max}_{j} \{ {ω}_{ij} \} , j = 1 , 2 , … , L$$
$$D = max \{ W , H \}$$
$${ϕ}_{ij} = {\sum }_{s = 1}^{d} \vert {u}_{si} - {u}_{sj} \vert$$
$${ω}_{ij} = \sqrt{{( {x}_{pi} - {x}_{pj} )}^{2} + {( {y}_{pi} - {y}_{pj} )}^{2}}$$
wherein, φᵢⱼ represents a dissimilarity between image blocks pᵢ and pⱼ, ωᵢⱼ represents a distance between image blocks pᵢ and pⱼ, uₘₙ represents an element at a m-th row and a n-th column of the matrix U, (xₚᵢ,yₚᵢ) and (xₚⱼ,yₚⱼ) respectively represent coordinates of the image blocks pᵢ and pⱼ to a center on the original inquired image I;
step 2.3), organizing visual saliency values of all image blocks into a two-dimensional form according to positional relationships among the image blocks on the original inquired image I, to constitute a saliency map SalMap which is calculated as:
SalMap(i,j)=Sal_{(i-1)·N+j} i=1, . . . ,J, j=1, . . . ,N
step 2.4), imposing a central bias on the saliency map obtained in step 2.3) according to a central bias principle of human eyes, and smoothing it through a two-dimensional Gaussian smoothing operator to obtain a final resulted map, the formulas being the following:
$${SalMap}^{′} ( i , j ) = SalMap ( i , j ) \times AttWeiMap ( i , j )$$
$$AttWeiMap ( i , j ) = 1 - \frac{DistMap ( i , j ) - min \{ DistMap \}}{max \{ DistMap \} - min \{ DistMap \}}$$
$$DistMap ( i , j ) = \sqrt{{( i - ( J + 1 ) / 2 )}^{2} + {( j - ( N + 1 ) / 2 )}^{2}}$$
wherein, i=1, . . . , J, j=1, . . . , N, AttWeiMap is an average attention weight map of human eyes which has a same size as that of the saliency map SalMap, DistMap is a distance map, and max{DistMap} and min{DistMap} are respectively a maximum value and a minimum value of the distance map.

7. The method for retrieving a similar image based on visual saliencies and visual phrases of claim 6, characterized in that, the inquired image I has a width W, a height H, if W=H, the whole inquired image is divided into L non-overlapping image square blocks, and if W≠H, after the inquired image is divided into L non-overlapping image square blocks, remaining parts which are not divided are kept at edges of the inquired image.

8. A method for retrieving a similar image based on visual saliencies and visual phrases, characterized in that, the method comprises the following steps:
step 1), inputting an inquired image I;
step 2), calculating a saliency map of the inquired image I;
step 3), performing viewpoint shift on the saliency map of the inquired image I obtained in step 2) by utilizing a viewpoint shift model, defining a saliency region as a circular region which taking a viewpoint as a center and R as a radius, and shifting the viewpoint for k times to obtain k saliency regions of the inquired image;
step 4), constructing a dictionary: extracting SIFT feature points from different types of images in the inquired image library by utilizing a SIFT algorithm, for a set of vectors of all SIFT feature points, merging similar SIFT feature points by utilizing a K-Means clustering algorithm, to construct a dictionary containing m words; extracting a number of appearance times of each word of the m visual words in each saliency region of the inquired image I, and a number of appearance times of a j-th visual word wordⱼ^{(k)} in a k-th saliency region regionₖ being denoted as ωⱼ^{(k)}; constructing a visual phrase: wordⱼ^{(k)} and word_{j′}^{(k)} constituting a visual phrase phrase_{jj′}^{(k)} if both of the two different visual words wordⱼ^{(k)} and word_{j′}^{(k)} appear in a same saliency region and j≠j′; calculating a frequency of a visual phrase: firstly, respectively calculating a number of appearance times p_{jj′}^{(k)} of a visual phrase phrase_{jj′}^{(k)} in each of the saliency regions: taking a minimum one of the numbers of appearance times of two different visual words wordⱼ^{(k)} and word_{j′}^{(k)} as the number of appearance times p_{jj′}^{(k)} of the visual phrase_{jj′}^{(k)} consisting of the two words:
p_{jj′}^{(k)}=min(ωⱼ^{(k)},ω_{j′}^{(k)})
secondly, representing numbers of appearance times of all of the visual phrases in the saliency region regionₖ as:
$${P}^{( k )} = [ \begin{matrix}{p}_{11}^{( k )} & {p}_{12}^{( k )} & … & {p}_{1 m}^{( k )} \\ {p}_{21}^{( k )} & {p}_{22}^{( k )} & … & {p}_{2 m}^{( k )} \\ ⋮ & ⋮ & ⋱ & ⋮ \\ {p}_{m 1}^{( k )} & {p}_{m 2}^{( k )} & … & {p}_{mm}^{( k )}\end{matrix} ]$$
thirdly, superimposing matrixes P^{(k)} of the former k regions, to obtain a matrix PH of numbers of appearance times of all of the visual phrases of the inquired image I:
$$PH = [ \begin{matrix}{ph}_{11} & {ph}_{12} & … & {ph}_{1 m} \\ {ph}_{21} & {ph}_{22} & … & {ph}_{2 m} \\ ⋮ & ⋮ & ⋱ & ⋮ \\ {ph}_{m 1} & {ph}_{m 2} & … & {ph}_{mm}\end{matrix} ]$$
wherein,
$${ph}_{{jj}^{′}} = {\sum }_{i = 1}^{k} {p}_{{jj}^{′}}^{( i )}$$
representing the inquired image I with the visual phrases: representing the inquired image I as a matrix PH(I) according to the numbers of appearance times of all of the visual phrases in all of the saliency regions in the previous step, wherein PH(I) is symmetric with respect to a main diagonal, and its upper triangular matrix covers all information of the matrix, and jointing an upper triangular part of PH(I) row by row or column by column into a vector, to obtain a descriptor V(I) of the inquired image I;
step 5), performing steps 1), 2), 3) and 4) with respect to each image in an inquired image library, until an image descriptor V(I_{i′}) of each image is obtained; and
step 6), calculating a similarity value between the inquired image and each image in the inquired image library depending on the image descriptors by utilizing a cosine similarity, to obtain an image similar to the inquired image from the inquired image library.
